(19) United States
(12) Patent Application Publication
(10) Pub. No.: US 2014/0376336 A1
(43) Pub. Date: Dec. 25, 2014

(54) NON-IONIZING AND NON-MRI METHODS FOR INTERROGATING MR CONDITIONAL STATUS OF IMPLANTED DEVICES

(71) Applicants: Toshiba Medical Systems Corporation, Otawara-shi (JP); Kabushiki Kaisha Toshiba, Minato-ku (JP)

(72) Inventors: Michael STECKNER, Beachwood, OH (US); Christopher J. Sanders, Redmond, WA (US); Gilles D. Guenette, Sammamish, WA (US); Zoran Banjanin, Bellevue, WA (US)

(21) Appl. No.: 13/921,388

(22) Filed: Jun. 19, 2013

(51) Int. Cl. G08C 23/02

(52) U.S. Cl. CPC G08C 23/02
USPC 367/197

(57) ABSTRACT

A method and system of obtaining information by interrogating an information mark attached to a device implanted in a body of a patient by transmitting a non-ionizing pulse through the body of the patient, receiving, from the information mark, a response to the transmitted non-ionizing pulse, the response including encoded information, and extracting the encoded information from the response.

### FIELD

The present disclosure generally relates to an apparatus and method for interrogating magnetic resonance (MR) conditional status of implanted devices using non-ionizing and non-magnetic resonance imaging techniques.

### BACKGROUND

MR scanning of a patient having an implanted device, such as a medical device, can be dangerous. For example, certain types of devices, like pacemakers and neuro-stimulators, when scanned in an MRI can kill, significantly impair, or injure the patient. A conventional approach for determining whether an implanted device is MR compatible is to determine if there are any associated instructions on how to appropriately scan the device in the MRI. For example, the vendor of the implant may have performed some testing, and determined that a patient having the unit placed therein can utilize a MR scanner as long as the MR operator follows the conditions included with the device instructions to ensure the patient can be safely scanned in the MRI. One approach for including instructions is via an MR conditional mark. Such a mark may be readable before insertion into a patient and/or may be readable via X-ray or found in the accompanying documents of the device. For example, when the mark is X-ray readable, this process requires X-raying the patient and looking for “radio opaque” (RO) markers. Such markers may be seen on the X-ray of the body part but information on the manufacturer, serial number, MRI compatibility is not visible. In addition, not all X-ray devices can clearly identify the markers, and not all patients are or can be X-rayed for this purpose. Furthermore, health concerns about ionizing radiation, whether the particular imaging center even has X-ray equipment, and whether standard work flow procedures at any given imaging center even permit such images to be collected, are all reasons why X-ray imaging has significant drawbacks in this context.

With the above limits and concerns understood, there is a need to acquire necessary information by non-ionizing means, quickly, easily and with limited expense, hassle, and time. While there are well known “RFID” type technologies that can actively provide this information, there may be a multitude of implant vendors with their own device interrogation units and the given MR imaging center may not have the correct device interrogation unit. Thus, there is a need for an identification tool that does not require telemetry.

### BRIEF DESCRIPTION OF THE DRAWINGS

A more complete appreciation of the embodiments described herein, and many of the attendant advantages thereof will be readily obtained as the same becomes better understood by reference to the following detailed description when considered in connection with the accompanying drawings, wherein:

FIG. 1 shows an example of an information mark according to one embodiment;

FIG. 2 shows an example of the information mark on a lead and a device according to another embodiment;

FIG. 3 illustrates an example of an information mark according to one embodiment;

FIG. 4A and FIG. 4B illustrate an example of an information mark according to one embodiment;

FIG. 5 illustrates an information mark according to another embodiment;

FIG. 6 illustrates an information mark according to another embodiment;

FIG. 7 shows an exemplary process diagram according to an embodiment;

FIG. 8 shows an exemplary system diagram according to an embodiment; and

FIG. 9 illustrates a computing device according to an embodiment.

### DETAILED DESCRIPTION

The present disclosure describes an apparatus and method for obtaining information from an implanted information mark element.

Embodiments disclosed herein provide for a method of obtaining information by interrogating an information mark attached to a device implanted in a body of a patient by transmitting a non-ionizing pulse through the body of the patient, receiving, from the information mark, a response to the transmitted non-ionizing pulse, the response including encoded information, and extracting the encoded information from the response.

According to another embodiment of the method, the device is a medical device.

According to another embodiment of the method, the non-ionizing pulse is an ultrasound pulse.

According to another embodiment of the method, the non-ionizing pulse is a photoacoustic pulse.

According to another embodiment of the method, the response is a reflected non-ionizing pulse.

According to another embodiment of the method, the response is a resonation at a predetermined frequency.

According to another embodiment of the method, the response is a plurality of resonations at a plurality of predetermined frequencies.

According to another embodiment of the method, the response is an independently generated acoustic pulse transmission, light pulse transmission, or RF transmission, generated by the information mark.

According to another embodiment of the method, the information mark is included in a housing.

According to another embodiment of the method, varied placement of ultrasonic reflective material and ultrasonic absorbing material within the information mark is used to encode information.

According to another embodiment of the method, a strip of ultrasonic reflective material is positioned between strips of ultrasonic absorbing material within the information mark to further encode information.

According to another embodiment of the method, varied width of the strip of ultrasonic reflective material between the strips of ultrasonic absorbing material within the information mark is used to encode information.

According to another embodiment of the method, varied height of the strip of ultrasonic reflective material within the information mark is used to encode information.

According to another embodiment of the method, varied position of pins and plates within the information mark attached to the device is used to encode information.

According to another embodiment of the method, the attached pins and plates are positioned in a column within the information mark to encode information.

According to another embodiment of the method, the inclusion of a resonating bead within the information mark is used to encode information.

According to another embodiment of the method, the inclusion a plurality of resonating beads, which resonate at different frequencies, is used to encode information.

According to another embodiment of the method, the information mark stores information locally and transmits the encoded information in response to local power generation implemented by harnessing acoustic energy from the non-ionized pulse.

According to another embodiment of the method, the method includes the further step of determining information about the implanted device from the extracted encoded information.

Embodiments disclosed herein further provide for a system for obtaining information. The system includes a device implanted into a body of a patient, an information mark attached to the implanted device, an interrogating device that interrogates an information mark attached to the device implanted into a body of a by transmitting a non-ionizing pulse patient through the body of the patient, a receiving device that receives a response to the transmitted non-ionizing pulse from the information mark, the response including encoded information, and a processor configured to extract the encoded information from the response.

According to another embodiment of the system, the device is a medical device.

According to another embodiment of the system, the non-ionizing pulse is an ultrasound pulse.

According to another embodiment of the system, the non-ionizing pulse is a photoacoustic pulse.

According to another embodiment of the system, the response is a reflected non-ionizing pulse.

According to another embodiment of the system, the response is a resonation at a predetermined frequency.

According to another embodiment of the system, the response is a plurality of resonations at a plurality of predetermined frequencies.

According to another embodiment of the system, the response is an independently generated acoustic pulse transmission, light pulse transmission, or RF transmission, generated by the information mark.

According to another embodiment of the system, the information mark is included in a housing.

According to another embodiment of the system, varied placement of ultrasonic reflective material and ultrasonic absorbing material within the information mark is used to encode information.

According to another embodiment of the system, a strip of ultrasonic reflective material is positioned between strips of ultrasonic absorbing material within the information mark to further encode information.

According to another embodiment of the system, varied width of the strip of ultrasonic reflective material between the strips of ultrasonic absorbing material within the information mark is used to encode information.

According to another embodiment of the system, varied height of the strip of ultrasonic reflective material within the information mark is used to encode information.

According to another embodiment of the system, varied position of pins and plates within the information mark attached to the device is used to encode information.

According to another embodiment of the system, the attached pins and plates are positioned in a column within the information mark to encode information.

According to another embodiment of the system, the inclusion of a resonating bead within the information mark is used to encode information.

According to another embodiment of the system, the inclusion a plurality of resonating beads, which resonate at different frequencies, is used to encode information.

According to another embodiment of the system, the information mark stores information locally and transmits the encoded information in response to local power generation implemented by harnessing acoustic energy from the non-ionized pulse.

According to another embodiment of the system, the extracting unit is further configured to determine information about the implanted device from the extracted encoded information.

Embodiments disclosed herein further provide for an information mark for encoding information. The information mark includes a housing attached to an implanted device, and a plurality of beads disposed in the housing, each bead resonating at a predetermined frequency when interrogated by a non-ionizing pulse, the combination of beads disposed in the housing providing encoded information, which is discernible by capturing emitting pulses at the predetermined frequency.

According to another embodiment of the information mark, the information mark further includes an absorbing material disposed between the housing and the implanted device.

Embodiments disclosed herein further provide for a second information mark for encoding information. The information mark includes a housing implanted within a body of a patient, and a plurality of beads disposed in the housing, each bead resonating at a predetermined frequency when interrogated by a non-ionizing pulse, the combination of beads disposed in the housing providing encoded information, which is discernible by capturing emitting pulses at the predetermined frequency.

The present embodiments provide a way to detect an implanted device 1 and to detect whether the device 1 can be safely scanned in an MRI, given appropriate MR conditional instructions. Such detection can be difficult with a non-responsive patient, a patient that forgets their medical history, a patient without a knowledgeable companion, or a patient that might not speak the local language, etc. The present embodiments are not limited to detecting MR conditional instructions and can be used to detect any information from any implanted device 1.

The present embodiments provide a non-ionizing approach for obtaining information from an implanted device 1 that increases the safety to the patient, and provides the information as quickly and inexpensively as possible.

One embodiment described herein uses ultrasonic methods to interrogate the status of the implanted device 1. Other non-ionizing, non-MRI solutions, such as light, can be used to provide a similar solution.

Most implanted devices 1 are positioned near the skin surface of the patient. The pacemaker is probably the most commonly implanted active device and is positioned beneath the collarbone, either in the lower shoulder or upper pectoral area of the patient within a few centimetres of the skin surface. Ultrasound technology, such as, for example, a high frequency ultrasound, can be used to transmit energy and then read an identifying marker at high resolution from the device 1. Further, light-based and/or photoacoustic technologies can also be used for the transmission of energy for the purpose of reading an identifying marker. Laser based imaging may have a penetration of approximately 1-2 mm. Photoacoustic imaging, such as laser transmission with ultrasound reflection and receive, may have penetration of up to 50 mm or more.

Embodiments described herein involve placing an information mark such as a marker with special shape, or pattern of bars, dots, different materials, and or depths, etc. on the surface of the device 1 canister or on a lead, which provides the necessary information. Ultrasound, or light, or any other suitable non-ionizing, non-MRI technology can be used to transmit energy into the body, for subsequent reading of the shape, pattern, etc. of the implanted device 1. A further embodiment, implemented with ultrasound-based technology, involves the use of special resonators whose resonant frequency or frequencies provide a functional equivalent of a marker. The resonation-based marker can be multi-level and have different sonic absorption properties. This information mark can use any method, combination, spatial or frequency pattern that, on interrogation, returns the needed information.

The information obtained in each of the embodiments can be decoded by the system so that other tables of information do not need to be manually consulted for proper interpretation.

Furthermore, sonic keys, such a particular resonating element, can be placed at the corners of the implanted device 1 in order to enable a determination regarding when a good position has been reached by an interrogating unit, such as an ultrasound device, so that the data can be fully and accurately read.

The embodiments provide details regarding different approaches to an information mark or marker associated with the implanted device 1. Various marker shapes, or a 2D bar code, or any spatial array, including 3D shapes, can be organized to contain information. As is noted above, further embodiments substitute or supplement the physical marker with tuned resonators such that when the ultrasonic sound hits the resonators, the resonators emit a specific frequency. The resonators also can be tuned only to resonate at a particular frequency. However energized, the resonant frequency (or frequencies) themselves are the encoded information.

Further embodiments describe inputting acoustic energy that is captured by the device 1 and used to drive an electric circuit, which in turn then emits the encoded information for local reception. There are multiple different forms of information transmission in these embodiments.

An ultrasound unit, a light-based unit, or other non-ionizing device can be used to interrogate the device 1 to enable reading of the information encoded on or attached to the implanted device 1. The read information can be presented as an image to the operator to enable manual or remote decoding, or some signal/image processing can be applied to computationally decode the encoded information from the obtained information. In at least one embodiment, MR conditional statements can be contained in the encoded information.

The system can be omni-directional such that it does not matter from what angle the input pulse is presented. Furthermore, the output can be transmitted or broadcast in all directions depending on the embodiment.

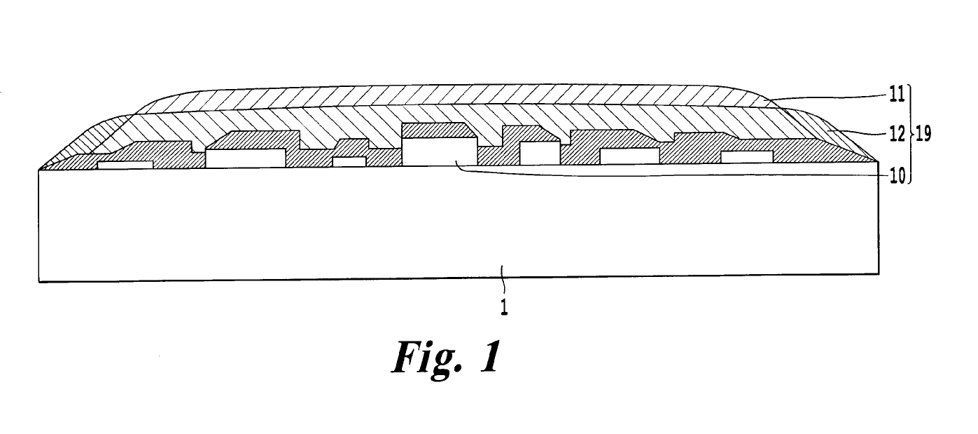

Referring now to the drawings, wherein like reference numerals designate identical or corresponding parts throughout the several views, FIG. 1 shows an example of a first embodiment in which a physical shape is applied to the surface of implanted device 1. In this embodiment three different materials are used to encode information in the information mark element 19. In particular, the code is made up of: ultrasound reflective 10, ultrasound absorbing 12, and ultrasound standoff 11 materials. The ultrasound standoff material is a biocompatible ultrasound lucent material that provides a number of functional characteristics. For example, the ultrasound standoff material is able to protect tissues from interaction with other code materials that can have edges. The ultrasound standoff material is also able to provide a consistent space from the patient tissues to the code and to provide a raised palpation surface (raised) that clinicians can use to position the reading device. The standoff material is able to prevent interference, such as a ultrasound “Main Bang” echo, from distorting axial resolution of the code (artifact reduction).

In this embodiment, information is encoded in at least a combination of the following code attributes: width of reflective surface, height of reflective surface, width/depth of absorbing surface, beginning of the code, and end of the code. In addition, the code can be encoded based on the combination of different reflective and/or absorbing surfaces. For example, a narrow reflective surface stripe adjacent to a wide absorbing surface stripe, which is also adjacent to a different wide reflective surface, can provide some unique information. The reflective and absorbent surfaces can be arranged in any shape such as blocks, stripes, circles, etc. As is illustrated in FIG. 1, different heights of the reflective surfaces as well as different widths and/or depths of the reflective and absorbing surfaces are used to encode information.

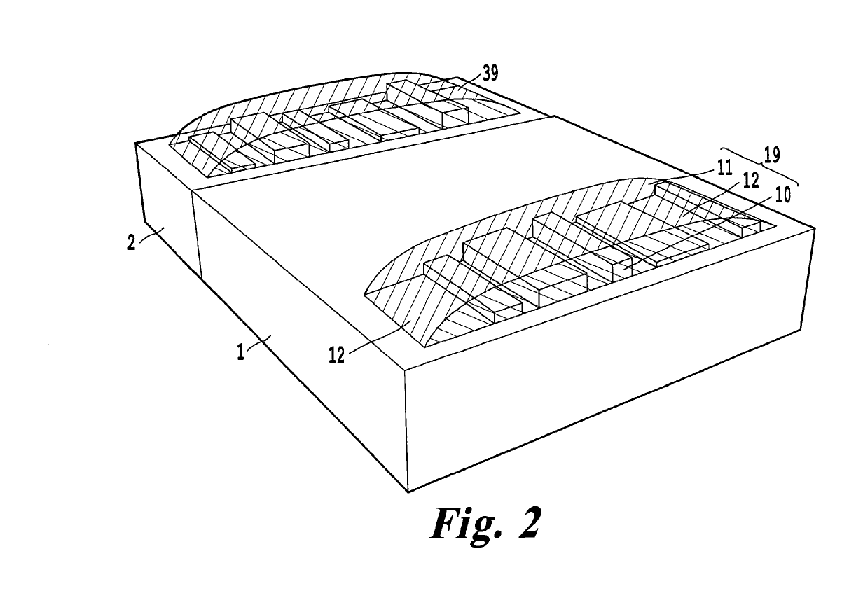

As is shown in FIG. 2, multiple codes can be provided to convey different information such as the identification of pacemaker device 1 and the leads 2 which are also implanted. For example, a lead 2 can have an information mark 39 which is provided along with a device information mark 19. The lead mark 39 and the device mark 19 can be positioned on the lead 2 and the device 1, respectively, or the lead mark 39 and the device mark 19 can both be positioned on the same location. Because old leads may sometimes remain in the patient after a corresponding device is removed and a new device is implanted, the lead mark 39 can be independent of the device mark 19. The lead mark 39 can be placed on any portion of the lead 2 but the lead mark 39 will often be placed close to where the lead 2 connects to the device 1. Thus, in order to avoid overlap, the device mark 19 can be positioned on an opposite side of the device 1 from where the lead enters the device 2. However, the system is not limited to such a configuration and the device mark 19 can be positioned anywhere on the device 1.

In addition, the device mark 19 and the lead mark 39 can be positioned on two or more sides of the device 1 or lead 2, respectively. Such a configuration addresses the situation in which the device 1 flips or moves within the body.

The present embodiment can be utilized with an ultrasonic device which is able to distinguish the different types of materials. For example, the present embodiment can be utilized with a phased array transducer which provides information about both the width and height of the reflective material. The present embodiment can also be utilized with a 2D mode ultrasound device when there is no information encoded using elevation as is shown in FIG. 1 and FIG. 2. For example, in the example of FIGS. 1 and 2, the 2D imaging device images are like slices with one dimension depth and other lateral. In particular, in FIGS. 1 and 2, the lateral dimension is illustrated as left-right, with the elevation being toward the paper. The information also could be encoded in elevation dimension and, as a result, a 3D imaging device could be used to read information coded in all three dimensions.

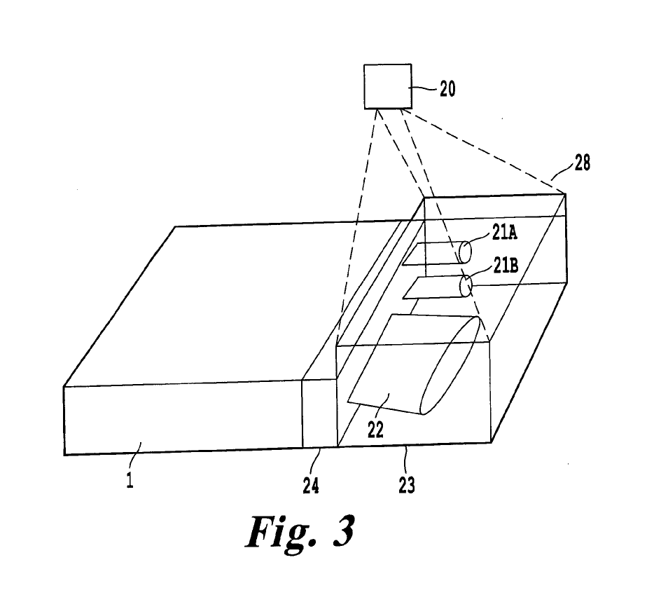

An additional embodiment is illustrated in FIG. 3. In this embodiment, the information is physically encoded on the mark 28 by way of pins and plates. As is shown in FIG. 3, the pins 21A and 21B and the plate 22 are positioned on the side of the implanted device 1. The number of pins and plates shown in FIG. 3 is exemplary any number of pins and plates of varying sizes can be used to encode information. The pins 21A-B and the plate 22 are encased in an ultrasound transparent housing 23. This housing 23 can be a solid material or can be a container. The container can be filled any of a variety of materials which can be commonly found in commercial ultrasound phantoms which mimic tissue, bone or other physiology. The materials are physically and acoustically durable and stable. The materials could have similar acoustic and physical properties to the properties of rubber based tissue-mimicking material in ultrasound teaching phantoms, for instance. This material also will also comply with all requirements for implants materials. Construction of the housing 23 is inspired by a typical ultrasound phantom. Moreover, the side positioning of the housing 23 minimizes reflection from the implanted device 1. Reflection from the housing 23 is further reduced by placing ultrasound absorbing material 24 between the housing 23 and the device 1.

The position and orientation of the plate 22 on the side of the housing 23 is used for coding information. This information can reflect information about the MR status of the device 1 or can include additional information such as the manufacture of the device 1 or any other information about the patient or the device. In addition, the position of the pins 21 with respect to the edges of the housing 23 and/or the device 1 and/or with respect to the plate 22 or plates 22 can be used to encode information. The pins 21A/B and plates 22 are positioned on the side of the device 1 in order to take advantage of ultrasound's inherently superior axial resolution. For example, a 1D transducer array 20 can be placed above the pins 21A/B and plates 22 and the housing so that a resulting 2D slice image contains all pins 21A/B and plates 22 used for coding. The housing 23 can be positioned higher or lower than the implanted device 1 in order to facilitate the transducer positioning. The present embodiment can also be implemented with a phased array transducer or with a light-based and/or photoacoustic system.

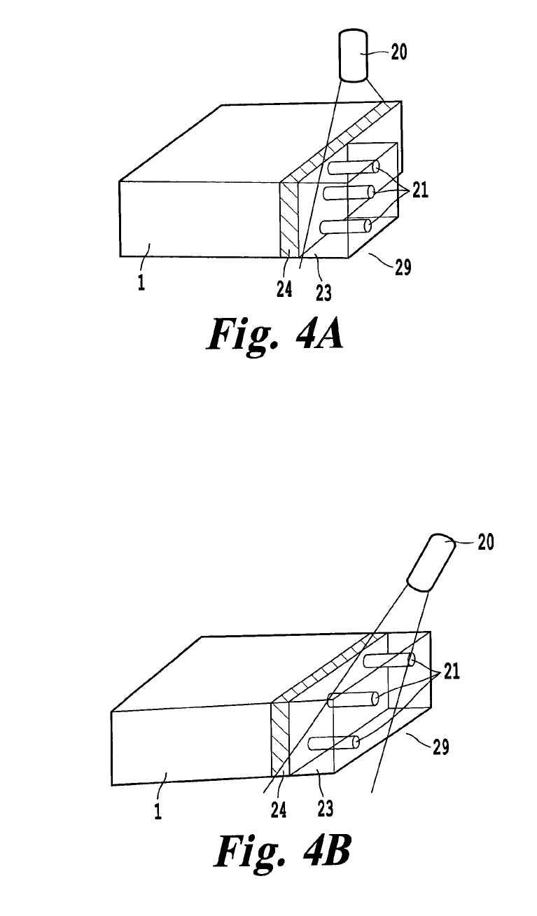

FIGS. 4A and 4B illustrate another embodiment in which the pins and plates are used with A-line imaging for the information mark 29. In this embodiment the pins 21 and plates 22 are placed along a single column so that single beam generated by single element piston transducers can be used for transmitting (Tx) and receiving (Rx). As is shown in FIGS. 4A and 4B, the pins 21 and plates 22 are oriented in a single column on the side of the device 1 in a housing 23. Imaging is performed with single vertical A-line device as is shown in FIG. 4A. If the vertical dimension of device 1 is not large enough to provide space for a sufficient number of pins 21 and plates 22, the A-line imaging can be performed diagonally as is shown in FIG. 4B.

A wedge, such as a triangle shaped wedge, can be added in front of a single piston transducer to simplify selection of right angle and diagonal and simplify the entire imaging process. In addition, a non-focused ultrasound can be utilized to obtain information encoded in the pins 21 and plates 22.

Similarly to the embodiment shown in FIG. 3, the embodiment shown in FIGS. 4A and 4B can use any combination of pins 21 and plates 22 as long as the elements are aligned. The housing 23 can be lower or higher than the device 1 or can be flush with the device 1 as is shown in FIGS. 4A and 4B. In addition, the housing 23 can be positioned against the entire side of the device 1 or can only be positioned against a portion of the device 1. An example of this partial orientation is shown in FIG. 4A. These features can also apply to the embodiment shown in FIG. 3.

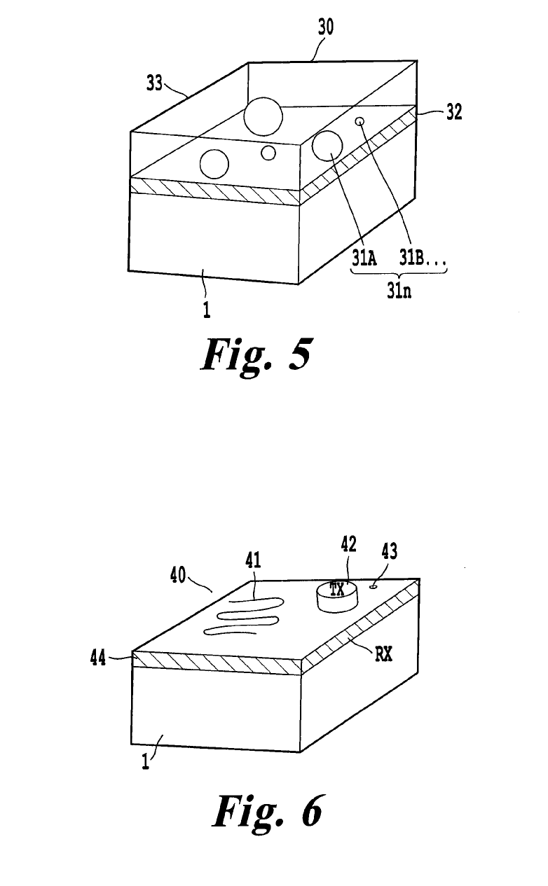

FIG. 5 illustrates an additional embodiment. In this embodiment, there is described a passive transponder with resonating beads which acts as the information mark 30. The passive transponder acts as a receiver transmitter and transmitter. In particular, resonating beads 31 A/B, such as sub-millimeter resonating beads, are used to encode information. The sub-one millimeter beads can be excited with, for example, a 2 MHz signal or higher frequency signals. Larger beads can be used with a lower frequencies. For instance, beads can be provided at different sizes and in a number limited only by the space in the housing 33. These different sized beads operate at different resonating frequencies. Encoding of the information is achieved by inserting various frequency beads 31A/31n into the housing 33. Encoding can also be achieved by a single bead having a predetermined frequency representing a specific device make/model or representing MR compatible or not.

The housing 33 is an ultrasound transparent housing similar to the housing 23. However, the housing 33 must include a cavity for the beads 31A/31n to resonate. The beads 31A/31n are space separated from the device 1 in order to reduce interference from very strong implant front face reflection. The bead signals can be separated from interference by time gating. In addition, interference from the device 1 is reduced by the inclusion of ultrasound absorbing material 32 between the housing 33 and the device 1.

The housing 33 can be positioned on any side of the device 1. For instance, FIG. 5 illustrates an example in which the housing 33 is on the top of the device 1. The housing 33 can also be oriented on multiple sides of the device such that two or more housings 33 are provided. The housing 33 may span the entire device 1 or may only cover a portion of the device 1.

Information is obtained from the resonating beads by sweeping all potential frequencies using any ultrasound device. For example, a 1D piston mechanically focused transducer can be used for both transmit (Tx) and receive (Rx). The resonating beads 31A/31n will respond to the acoustic energy transmitted at the respective resonating frequency and produce an echo signal detected by the transducer outside of the patient's body. This embodiment can also be implemented using laser as a transmitter and an ultrasound receiver.

FIG. 6 illustrates an active transponder embodiment. In this embodiment acoustic energy is captured by the mark device 40 and used to power the mark device 40 and the transmitter 41-43. For example, 1 W of acoustic energy can be converted into electric energy and stored or immediately utilized. This conversion can be accomplished using piezoelectric generation resulting from acoustic energy interacting with the crystal 44.

The generated electric energy can be used for acoustic energy transponding (transmitter-responder) using the crystal 44 or a different acoustic crystal 42 for transmission of the device codes and signals. Acoustically generated electric energy can also be converted and transmitted as an RF signal by RF transmitter 41 and/or light transmitter 43.

FIG. 6 illustrates a transponder having a receiving crystal 44, which covers the entire front plate of the device 1. The receiving crystal 44 can also cover only a portion of the device. The crystal can also be isolated from the device 1 by a protective layer. FIG. 6 also illustrates transmitting elements 41 (RF transmitter), 42 (acoustic transmitter) and 43 (light transmitter). These elements can be attached to the receiving crystal 44. Suitable circuitry, electrical storage devices, active and/or passive memory elements storing the information, and processing circuits can also be attached. An ultrasound device can be used to generate the acoustic energy for the mark device 40. For example, a 1D piston mechanically focused transducer can be used for transmitting (Tx). This transducer can also be used for receive (Rx) when acoustic transmission is performed by the mark device 40.

Because the mark device 40 is generating energy-based on the input acoustic energy, a large amount of information can be stored and transmitted by the mark device 40. The device is able to provide a stream of information from a memory or circuit on the mark device 40. The mark device 40 can also be connected to the device 1 and can obtain information therefrom.

Each of the embodiments described above can be implemented with encoded information that is fully or partially scrambled in order to protect patient privacy in agreement with HIPAA. In addition, the scrambled information can be used for differentiating implants from other objects during Airport/Border security suspicious object detections. This scrambled information can simplify screening of patients with implants.

In addition, each of the embodiments describe above can be implemented using photoacoustic principle. For example, transponding and imaging can be based on a photoacoustic principle. In this example, the light source can be used as transmitter that heats tissue thereby creating unique ultrasound waves that, based upon their energy absorption, expansion, and reflection properties, can be actively or passively transponded or used for imaging.

Light may be used to directly read the marker in the patient. For example, in some circumstances in which the marker is located near enough to the surface, light or laser with special detection mechanisms could be used to read the label directly. For instance, dots and structures on the internal marker could be read in a fashion similar to the surface/holes of a compact disk.

It is also possible to use fluorescing markers. These markers can be activated using light such that the activate fluorescing markers could then be read out.

Furthermore, low level long lasting radioactive markers may also be used to provide an indication of MR conditional marking. For instance, if the particular isotope/energy is detected this will act as a identifier indicating that further investigation is necessary because the device may have MR conditional marking.

Both the fluorescing and low level radiation markers may act as a “pre investigation” simple marker.

Each of the embodiments described herein can be used with a lead 2, in addition to a device 1, such that the information is encoded on the lead 2. For example, a housing 23/33 having beads or pins, etc. or a mark device 40 can also be included on a lead 2.

Each of the embodiments described herein can also be incorporated into the body of the device 1 or into the canister of the device 1.

The present embodiments provide significant advantages. For example, as is described above, existing approaches use ionizing radiation that poses health concerns for the patient. In addition, these X-ray-based methods do not work well in all instances. There are also practical considerations whether the X-ray equipment is even available and whether transporting the patient to the X-ray equipment is part of the regular work flow. The present embodiments can be implemented with hand-held ultrasound type devices, has no health concerns, and is fast and convenient. Furthermore, although imaging may be used, at least some of the embodiments can be employed without imaging. Thus the embodiments describe a way of using ultrasound for reading symbols, materials, or frequencies that represent information (data) rather than physiology. It is also highly beneficial to eliminate the potential harm of an X-ray.

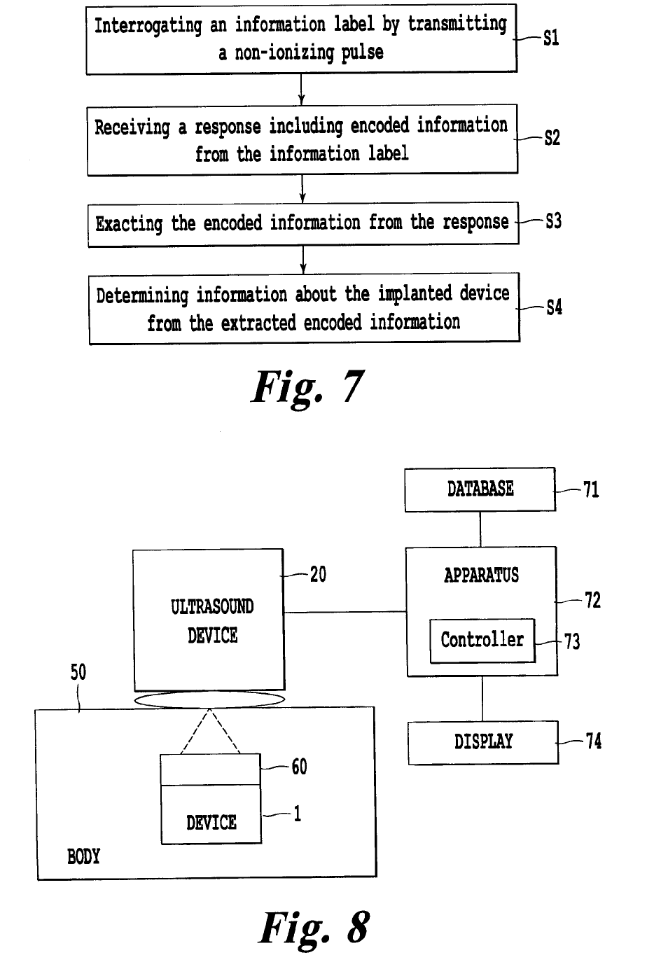

FIG. 7 illustrates a method according to the embodiments. This figure illustrates a method for obtaining information from an implanted device.

In step S1, an information mark such as marks 19, 39, 28, 29, 30, and 40, can be interrogated by a transmission of a non-ionizing pulse such as an ultrasound pulse which is transmitted to the device. The method can also include a pre-step of positioning a device such as an ultrasound device such that the device is properly placed for operation. As is noted above, sonic keys can be placed at the corners of the implanted device 1 in order to enable a determination regarding when a good position has been reached by an interrogating unit such as an ultrasound device, so that the data can be fully and accurately read.

In step S2, a response to the interrogation in received at the same device which transmitted the pulse or a different device. The response includes encoded information. For example, the information can be encoded in the image data obtained by an ultrasound imaging device. The information can also be encoded in the existence of certain frequencies or values.

In step S3, the encoded information is extracted from the response. For example, the information is translated by a decoding algorithm which translates the information found in the response into information which is understandable by an operator. For example, certain widths of strip of the reflective material in the first embodiment can indicate a particular byte of data which when combined with each of the different widths can generate a hexadecimal value corresponding to a particular manufacturer of device. Any type of information can be encoded in the information mark. A simply bar code is an example of how information can be encoded in a binary image. Additional information can be encoded using different techniques into an ultrasound image or from frequency information map.

Once the encoded information is extracted, in step S4, information can be determined about the implanted device 1 or the lead 2 or the patient. For example, the information mark can provide an indication that it is safe to utilize the device 1 in a MR machine.

An additional step of displaying the information to the operator can additionally be provided.

FIG. 8 illustrates a system according to one embodiment. In this figure there is shown a device 1 implanted in the body 50. Attached to the device 1 is an information mark 60. This information mark can be any of the information marks 19, 39, 28, 29, 30, and 40. The mark 60 is interrogated by a pulse from ultrasound device 20. The ultrasound device 20 can be replaced with any non-ionizing pulse producing device. The response from the interrogation is read by the transducer 20 and is transmitted to apparatus 72. The apparatus 72 implements a process using specially programmed controller 73 to decode the information obtained in the response and determine information about the device and/or the patient. The decoding process can use information from database 71 which can store additional information about the patient or the device 1 which can be accessed based on information obtained from the information mark. The apparatus 72 can also be programmed to de-scramble or decrypt the information found on the information mark. The information is then presented to the operator via display 74. The obtained information can also be stored for future access or shared.

According to an additional embodiment the identifying mark, such as information marks 19, 39, 28, 29, 30, and 40, can be independently placed in the body of the patient without being attached to a device 1. For instance, the identifying mark can be packaged separately and located elsewhere in the body.

Furthermore, identifying mark can act as a unique identifier. When a response is received from the interrogation by a non-ionizing pulse, the unique identifying can be used to query a central database. The central database can simply be updated with new information when a new device is added or a modification is made. The ultrasound device or the associated system may contact a central database via a network such as the interne, for device identification and/or information retrieval. There is no need for the unique identifier to be fixed to a device 1. For instance, these special markers or identifying entities do not necessarily have to be co-located with the implanted device. There may be reason to position the markers at another location within the body for convenience, or position these special markers at both the implanted device 1 and another marker repository location.

At least certain portions of the processing described above, such the translation of the obtained information can be implemented or aided by using some form of embedded or external computer having at least one microprocessor or by using a processor. As one of ordinary skill in the art would recognize, the computer processor can be implemented as discrete logic gates, as an Application Specific Integrated Circuit (ASIC), a Field Programmable Gate Array (FPGA) or other Complex Programmable Logic Device (CPLD). An FPGA or CPLD implementation can be coded in VHDL, Verilog or any other hardware description language and the code can be stored in an electronic memory directly within the FPGA or CPLD, or as a separate electronic memory. Further, the electronic memory can be non-volatile, such as ROM, EPROM, EEPROM or FLASH memory. The electronic memory can also be volatile, such as static or dynamic RAM, and a processor, such as a microcontroller or microprocessor, can be provided to manage the electronic memory as well as the interaction between the FPGA or CPLD and the electronic memory.

Alternatively, the computer processor can execute a computer program including a set of computer-readable instructions that perform the functions described herein, the program being stored in any of the above-described non-transitory electronic memories and/or a hard disk drive, CD, DVD, FLASH drive or any other known storage media. Further, the computer-readable instructions can be provided as a utility application, background daemon, or component of an operating system, or combination thereof, executing in conjunction with a processor, such as a Xenon processor from Intel of America or an Opteron processor from AMD of America and an operating system, such as Microsoft VISTA, UNIX, Solaris, LINUX, Apple, MAC-OSX and other operating systems known to those skilled in the art.

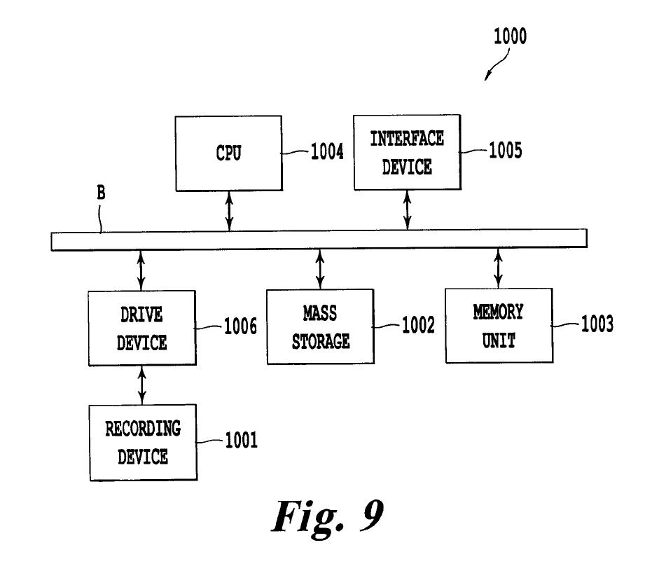

In addition, certain features of the embodiments can be implemented using a computer-based system (FIG. 9). The computer 1000 includes a bus B or other communication mechanism for communicating information, and a processor/CPU 1004 coupled with the bus B for processing the information. The computer 1000 also includes a main memory/memory unit 1003, such as a random access memory (RAM) or other dynamic storage device (e.g., dynamic RAM (DRAM), static RAM (SRAM), and synchronous DRAM (SDRAM)), coupled to the bus B for storing information and instructions to be executed by processor/CPU 1004. In addition, the memory unit 1003 can be used for storing temporary variables or other intermediate information during the execution of instructions by the CPU 1004. The computer 1000 can also further include a read only memory (ROM) or other static storage device (e.g., programmable ROM (PROM), erasable PROM (EPROM), and electrically erasable PROM (EEPROM)) coupled to the bus B for storing static information and instructions for the CPU 1004.

The computer 1000 can also include a disk controller coupled to the bus B to control one or more storage devices for storing information and instructions, such as mass storage 1002, and drive device 1006 (e.g., read-only compact disc drive, read/write compact disc drive, compact disc jukebox, and removable magneto-optical drive). The storage devices can be added to the computer 1000 using an appropriate device interface (e.g., small computer system interface (SCSI), integrated device electronics (IDE), enhanced-IDE (E-IDE), direct memory access (DMA), or ultra-DMA).

The computer 1000 can also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer 1000 can also include a display controller coupled to the bus B to control a display, for displaying information to a computer user. The computer system includes input devices, such as a keyboard and a pointing device, for interacting with a computer user and providing information to the processor. The pointing device, for example, may be a mouse, a trackball, or a pointing stick for communicating direction information and command selections to the processor and for controlling cursor movement on the display. In addition, a printer can provide printed listings of data stored and/or generated by the computer system.

The computer 1000 performs at least a portion of the processing steps of the invention in response to the CPU 1004 executing one or more sequences of one or more instructions contained in a memory, such as the memory unit 1003. Such instructions can be read into the memory unit from another computer readable medium, such as the mass storage 1002 or a removable media 1001. One or more processors in a multi-processing arrangement can also be employed to execute the sequences of instructions contained in memory unit 1003. In alternative embodiments, hard-wired circuitry can be used in place of or in combination with software instructions. Thus, embodiments are not limited to any specific combination of hardware circuitry and software.

As stated above, the computer 1000 includes at least one computer readable medium 1001 or memory for holding instructions programmed according to the teachings of the invention and for containing data structures, tables, records, or other data described herein. Examples of computer readable media are compact discs, hard disks, magneto-optical disks, PROMs (EPROM, EEPROM, flash EPROM), DRAM, SRAM, SDRAM, or any other magnetic medium, compact discs (e.g., CD-ROM), or any other medium from which a computer can read.

Stored on any one or on a combination of computer readable media, the present invention includes software for controlling the main processing unit 1004, for driving a device or devices for implementing the invention, and for enabling the main processing unit 1004 to interact with a human user. Such software can include, but is not limited to, device drivers, operating systems, development tools, and applications software. Such computer readable media further includes the computer program product of the present invention for performing all or a portion (if processing is distributed) of the processing performed in implementing the invention.

The computer code elements on the medium of the present invention can be any interpretable or executable code mechanism, including but not limited to scripts, interpretable programs, dynamic link libraries (DLLs), Java classes, and complete executable programs. Moreover, parts of the processing of the present invention can be distributed for better performance, reliability, and/or cost.

The term “computer readable medium” as used herein refers to any medium that participates in providing instructions to the CPU 1004 for execution. A computer readable medium can take many forms, including but not limited to, non-volatile media, and volatile media. Non-volatile media includes, for example, optical, magnetic disks, and magneto-optical disks, such as the mass storage 1002 or the removable media 1001. Volatile media includes dynamic memory, such as the memory unit 1003.

Various forms of computer readable media can be involved in carrying out one or more sequences of one or more instructions to the CPU 1004 for execution. For example, the instructions can initially be carried on a magnetic disk of a remote computer. An input coupled to the bus B can receive the data and place the data on the bus B. The bus B carries the data to the memory unit 1003, from which the CPU 1004 retrieves and executes the instructions. The instructions received by the memory unit 1003 can optionally be stored on mass storage 1002 either before or after execution by the CPU 1004.

The computer 1000 also includes a communication interface 1005 coupled to the bus B. The communication interface 1004 provides a two-way data communication coupling to a network that is connected to, for example, a local area network (LAN), or to another communications network such as the Internet. For example, the communication interface 1005 can be a network interface card to attach to any packet switched LAN. As another example, the communication interface 1005 can be an asymmetrical digital subscriber line (ADSL) card, an integrated services digital network (ISDN) card or a modem to provide a data communication connection to a corresponding type of communications line. Wireless links can also be implemented. In any such implementation, the communication interface 1005 sends and receives electrical, electromagnetic or optical signals that carry digital data streams representing various types of information.

The network typically provides data communication through one or more networks to other data devices. For example, the network can provide a connection to another computer through a local network (e.g., a LAN) or through equipment operated by a service provider, which provides communication services through a communications network. The local network and the communications network use, for example, electrical, electromagnetic, or optical signals that carry digital data streams, and the associated physical layer (e.g., CAT 5 cable, coaxial cable, optical fiber, etc). Moreover, the network can provide a connection to a mobile device such as laptop computer, or cellular telephone.

In the above description, any processes, descriptions or blocks in flowcharts should be understood as representing modules, segments or portions of code which include one or more executable instructions for implementing specific logical functions or steps in the process, and alternate implementations are included within the scope of the exemplary embodiments of the present advancements in which functions can be executed out of order from that shown or discussed, including substantially concurrently or in reverse order, depending upon the functionality involved, as would be understood by those skilled in the art.

While certain embodiments have been described, these embodiments have been presented by way of example only, and are not intended to limit the scope of the inventions. Indeed, the novel methods, apparatuses and systems described herein can be embodied in a variety of other forms; furthermore, various omissions, substitutions and changes in the form of the methods, apparatuses and systems described herein can be made without departing from the spirit of the inventions. The accompanying claims and their equivalents are intended to cover such forms or modifications as would fall within the scope and spirit of the inventions.

1. A method of obtaining information, comprising:
interrogating an information mark attached to a device implanted in a body of a patient by transmitting a non-ionizing pulse through the body of the patient;
receiving, from the information mark, a response to the transmitted non-ionizing pulse, the response including encoded information; and
extracting the encoded information from the response.

2. The method according to claim 1, wherein the device is a medical device.

3. The method according to claim 1, wherein the non-ionizing pulse is an ultrasound pulse.

4. The method according to claim 1, wherein the non-ionizing pulse is a photoacoustic pulse.

5. The method according to claim 1, wherein the response is a reflected non-ionizing pulse.

6. The method according to claim 1, wherein the response is a resonation at a predetermined frequency.

7. The method according to claim 6, wherein the response is a plurality of resonations at a plurality of predetermined frequencies.

8. The method according to claim 1, wherein the response is an independently generated acoustic pulse transmission, light pulse transmission, or RF transmission, generated by the information mark.

9. The method according to claim 1, wherein the information mark is included in a housing.

10. The method according to claim 1, wherein varied placement of ultrasonic reflective material and ultrasonic absorbing material within the information mark is used to encode information.

11. The method according to claim 10, wherein a strip of ultrasonic reflective material is positioned between strips of ultrasonic absorbing material within the information mark to further encode information.

12. The method according to claim 11, wherein varied width of the strip of ultrasonic reflective material between the strips of ultrasonic absorbing material within the information mark is used to encode information.

13. The method according to claim 12, wherein varied height of the strip of ultrasonic reflective material within the information mark is used to encode information.

14. The method according to claim 1, wherein varied position of pins and plates within the information mark attached to the device is used to encode information.

15. The method according to claim 14, wherein the attached pins and plates are positioned in a column within the information mark to encode information.

16. The method according to claim 9, wherein the inclusion of a resonating bead within the information mark is used to encode information.

17. The method according to claim 16, wherein the inclusion a plurality of resonating beads, which resonate at different frequencies, is used to encode information.

18. The method according to claim 8, wherein the information mark stores information locally and transmits the encoded information in response to local power generation implemented by harnessing acoustic energy from the non-ionized pulse.

19. The method according to claim 1, further comprising:
determining information about the implanted device from the extracted encoded information.

20. A system for obtaining information, comprising:
a device implanted into a body of a patient;
an information mark attached to the implanted device;
an interrogating device that interrogates an information mark attached to the device implanted into a body of a by transmitting a non-ionizing pulse patient through the body of the patient;
a receiving device that receives a response to the transmitted non-ionizing pulse from the information mark, the response including encoded information; and
a processor configured to extract the encoded information from the response.

21. The system according to claim 20, wherein the device is a medical device.

22. The system according to claim 20, wherein the non-ionizing pulse is an ultrasound pulse.

23. The system according to claim 20, wherein the non-ionizing pulse is a photoacoustic pulse.

24. The system according to claim 20, wherein the response is a reflected non-ionizing pulse.

25. The system according to claim 20, wherein the response is a resonation at a predetermined frequency.

26. The system according to claim 25, wherein the response is a plurality of resonations at a plurality of predetermined frequencies.

27. The system according to claim 20, wherein the response is an independently generated acoustic pulse transmission, light pulse transmission, or RF transmission, generated by the information mark.

28. The system according to claim 20, wherein the information mark is included in a housing.

29. The system according to claim 20, wherein varied placement of ultrasonic reflective material and ultrasonic absorbing material within the information mark is used to encode information.

30. The system according to claim 29, wherein a strip of ultrasonic reflective material is positioned between strips of ultrasonic absorbing material within the information mark to further encode information.

31. The system according to claim 30, wherein varied width of the strip of ultrasonic reflective material between the strips of ultrasonic absorbing material within the information mark is used to encode information.

32. The system according to claim 31, wherein varied height of the strip of ultrasonic reflective material within the information mark is used to encode information.

33. The system according to claim 20, wherein varied position of pins and plates within the information mark attached to the device is used to encode information.

34. The system according to claim 33, wherein the attached pins and plates are positioned in a column within the information mark to encode information.

35. The system according to claim 28, wherein the inclusion of a resonating bead within the information mark is used to encode information.

36. The system according to claim 35, wherein the inclusion a plurality of resonating beads, which resonate at different frequencies, is used to encode information.

37. The system according to claim 27, wherein the information mark stores information locally and transmits the encoded information in response to local power generation implemented by harnessing acoustic energy from the non-ionized pulse.

38. The system according to claim 20, wherein
the extracting unit is further configured to determine information about the implanted device from the extracted encoded information.

39. An information mark for encoding information, comprising:
a housing attached to an implanted device;
a plurality of beads disposed in the housing, each bead resonating at a predetermined frequency when interrogated by a non-ionizing pulse, the combination of beads disposed in the housing providing encoded information, which is discernible by capturing emitting pulses at the predetermined frequency.

40. The information mark according to claim 39, further comprising:
an absorbing material disposed between the housing and the implanted device.

41. An information mark for encoding information, comprising:
a housing implanted within a body of a patient;
a plurality of beads disposed in the housing, each bead resonating at a predetermined frequency when interrogated by a non-ionizing pulse, the combination of beads disposed in the housing providing encoded information, which is discernible by capturing emitting pulses at the predetermined frequency.
